(19) United States
(12) Patent Application Publication
(10) Pub. No.: US 2003/0026667 A1
(43) Pub. Date: Feb. 6, 2003

(54) Stucco anchorage retrofit drill bit

(76) Inventor: Ben L. Schmid, Balboa Island, CA (US)

Correspondence Address: CHRISTIE, PARKER & HALE, LLP, P.O. BOX 7068, PASADENA, CA, 91109-7068, US

(21) Appl. No.: 10/211,810

(22) Filed: Aug. 2, 2002

Related U.S. Application Data
(60) Provisional application No. 60/309,938, filed on Aug. 3, 2001.

(51) Int. Cl. B23G 5/00; B27G 15/00; B23B 51/00; B23D 77/00; E21B 10/00

(52) U.S. Cl. 408/199; 175/327

(57) ABSTRACT

A drill bit assembly having a housing that has an outer diameter, an inner diameter and a distal radial shoulder extending therebetween at a distal end of the housing. A first drill bit has an outer diameter and an inner diameter, wherein the first drill bit outer diameter is less than the housing inner diameter. The first drill bit includes a shank portion that is mounted within the housing inner diameter and a drill portion that extends from the shank portion and axially protrudes from the distal radial shoulder of the housing. A second drill bit has an outer diameter that is less than the first drill bit inner diameter. The second drill bit includes a shank portion that is mounted within the first drill bit inner diameter and a drill portion that extends from the shank portion and axially protrudes from a distal end of the first drill bit. The first drill bit outer diameter is larger than the second drill bit outer diameter.

### CROSS-REFERENCE TO RELATED APPLICATION(S)

This application claims priority under 35 U.S.C. §119(e) to U.S. Provisional Application Serial No. 60/309,938, filed Aug. 3, 2001. The application is also related to co-pending U.S. patent applications No. ______, ______ and ______ (our refs. S196:48274, S196:48275 and S196:48276) filed on even date herewith, each of which is incorporated by reference.

### FIELD OF THE INVENTION

The present invention is related to a drill bit for drilling stucco sheathings, and more particularly, to a drill bit for drilling existing stucco, which is attached to the exterior of a building frame, so that a stucco fastener may be retrofitted to the stucco to improve the resistance of the stucco to shearing forces caused by seismic and hurricane lateral loading.

### BACKGROUND

As observed, reported and learned from nine California earthquakes since 1951, existing Portland cement-based exterior plaster (stucco) of wooden-framed structures has had little success in surviving intense lateral loads caused by earthquake, as well as hurricane forces. For example, the shaking intensity during the 1994 Northridge Earthquake, which in some locations reached magnitudes of 8 and 9 Modified Mercalli Intensity (MMI), was enough to detach stucco sheathings from the wooden frame of many one and two story single family residences and apartment buildings. Such detachment of the stucco sheathings from the wood framing resulted in heavy interior damage, uninhabitable structures and required the removal and replacement of the stucco sheathings.

A primary reason for the detachment of the stucco from the wood framing was the Uniform Building Code's approval of staples, since 1957, for attaching a reinforcing wire mesh to the wood framing prior to applying the stucco over the wire mesh coupled with the requirement of the Uniform Building Code in 1967 that a 26 gauge corrosion resisting continuous drip screed be installed against the mud sill plate, which is disposed along the lower portion of the wood framing. The mud sill plate has a minimum of a one inch overlap below the wood sill plate. The continuous drip screed is typically attached to the mud sill by the use of nails so that the stucco ends evenly just below the mud sill. Waterproof building paper and wire mesh or metal lath are then installed over the drip screed.

The wire mesh or metal lath is normally attached to the metal drip screed by use of the Uniform Building Code's specified staples, which are typically applied by use of a staple gun. Many times, the staple legs become bent and do not penetrate the metal drip screed. Staples used to fasten the wire mesh at the drip screed are often rusted out within a few years due to moisture rusting and weakening the thin staple legs. Stucco having poor lateral attachment to the mud sill due to unattached or rusted staples, typically fails at the wood sill plate during intense lateral displacement of the wood framing generated by such forces as earthquakes and/or hurricanes. Failure of the stucco sheathing generally results in heavy structural damage, often leaving the structure uninhabitable and needing complete replacement of the exterior stucco sheathing.

More recently, particularly in structures built after 1994, home builders have had limited success in improving the structural strength of the stucco sheathings by using furring nails to attach the wire mesh to the wood framing. Such nails are the subject of U.S. Pat. No. 1,517,035, wherein the head of the nail and a spacer concentrically disposed around the nail are configured to both retain the wire mesh and maintain the wire mesh at a distance apart from the underlying structure, or building paper, when the nail is driven into place within the framing. However, the use of such furring nails is labor intensive and cannot be retrofitted to strengthen existing stucco wall sheathings.

As a result, a stucco fastener for improving the strength of existing stucco sheathing against intense lateral forces, which is inexpensive and easily retrofitted to existing stucco sheathings has been developed, as is described in U.S. Provisional Application No. 60/309,802 and co-pending U.S. patent application No. ______ (Our ref. S196:48276), the disclosures of which are incorporated herein by reference.

Consequently, there is a need for a drill bit for drilling into existing stucco sheathings and the exterior of the building frame, to which the stucco is attached, so that a stucco fastener may be retrofitted thereto to improve the resistance of the stucco to shearing forces caused by seismic and hurricane lateral loads.

### SUMMARY OF THE INVENTION

An exemplary embodiment of the present invention includes a drill bit assembly having a housing that has an outer diameter, an inner diameter and a distal radial shoulder extending therebetween at a distal end of the housing. A first drill bit has an outer diameter and an inner diameter, wherein the first drill bit outer diameter is less than the housing inner diameter. The first drill bit has a shank portion that is mounted within the housing inner diameter and a drill portion that extends from the shank portion and axially protrudes from the distal radial shoulder of the housing. A second drill bit has an outer diameter that is less than the first drill bit inner diameter. The second drill bit includes a shank portion that is mounted within the first drill bit inner diameter and a drill portion that extends from the shank portion and axially protrudes from a distal end of the first drill bit, wherein the first drill bit outer diameter is larger than the second drill bit outer diameter.

Another exemplary embodiment of the present invention includes a drill bit assembly having a generally cylindrical housing having an outer diameter, an inner diameter and a distal radial shoulder extending therebetween at a distal end of the housing. A generally cylindrical first drill bit has an outer diameter and an inner diameter, wherein the first drill bit outer diameter is less than the housing inner diameter. The first drill bit includes a shank portion that is concentrically slidably mounted within the housing inner diameter and a drill portion that extends from the shank portion and axially protrudes from the distal radial shoulder of the housing, such that an axial length of the drill portion of the first drill bit is adjustable. A generally cylindrical second drill bit has an outer diameter that is less than the first drill bit inner diameter. The second drill bit includes a shank portion that is concentrically slidably mounted within the first drill bit inner diameter and a drill portion that extends from the shank portion and axially protrudes from a distal end of the first drill bit, such that an axial length of the drill portion of the second drill bit is adjustable and wherein the first drill bit outer diameter is larger than the second drill bit outer diameter.

A further embodiment of the present invention includes a method of improving lateral resistance of a stucco sheathing that is attached to a building frame including, providing a building frame, providing one or more layers of stucco sheathing and providing a drill bit assembly that includes a generally cylindrical housing having an outer diameter, an inner diameter and a distal radial shoulder extending therebetween at a distal end of the housing. A generally cylindrical first drill bit has an outer diameter and an inner diameter, wherein the first drill bit outer diameter is less than the housing inner diameter. The first drill bit includes a shank portion that is mounted within the housing inner diameter and a drill portion that extends from the shank and axially protrudes from the distal radial shoulder of the housing. A generally cylindrical second drill bit has an outer diameter than is less than the first drill bit inner diameter. The second drill bit includes a shank portion that is mounted within the first drill bit inner diameter and a drill portion that extends from the shank portion and axially protrudes from a distal end of the first drill bit and wherein the first drill bit outer diameter is larger than the second drill bit outer diameter. The drill bit assembly is used to drill a plurality of holes, wherein each hole extends through the stucco sheathing and into the building frame. A stucco fastener is installed in each drilled hole to secure the stucco sheathing to the building frame.

### BRIEF DESCRIPTION OF THE DRAWINGS

These and other features and advantages of the present invention will be better understood by reference to the following detailed description when considered in conjunction with the accompanying drawings wherein:

FIG. 1 is a partial perspective view of a stucco sheathing that has been applied to a typical structural framing;

FIG. 2A is a side cross-sectional view of the stucco sheathing and structural framing of FIG. 1 that have been drilled by a drill bit assembly according to the invention to produce a countersunk hole having a conically shaped countersink;

FIG. 2B is a side cross-sectional view of the stucco sheathing and structural framing of FIG. 1 that have been drilled by a drill bit assembly according to the invention to produce a countersunk hole having a cylindrically shaped countersink;

FIG. 3A is a cross-sectional view of a drill bit assembly according to the invention that may be used to produce the countersunk hole of FIG. 2A;

FIG. 3B is a cross-sectional view of a drill bit assembly according to the invention that may be used to produce the countersunk hole of FIG. 2B; and

FIG. 4 is a perspective view of an alternative embodiment of a second drill bit for use in a drill bit assembly according to the invention.

### DETAILED DESCRIPTION

The present invention is generally related to a drill bit for drilling an existing stucco sheathing, which is attached to the exterior of a building frame, so that a stucco fastener may be retrofitted to the stucco to improve the resistance of the stucco to shearing forces caused by seismic and hurricane lateral loads.

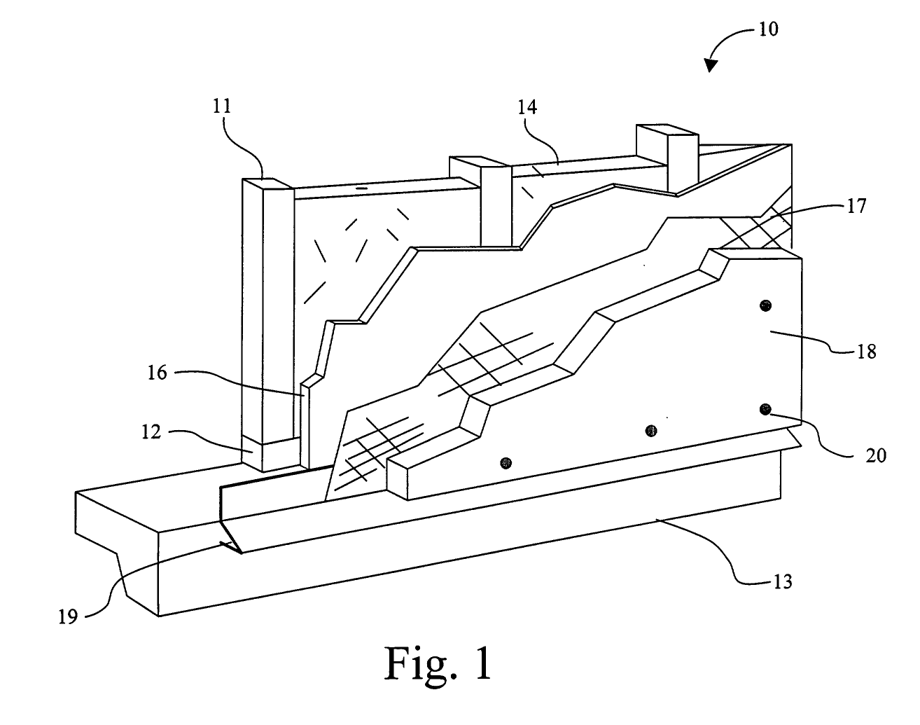

As shown in FIG. 1, a typical building structure or structural frame 10 comprises a series studs 11, such as 2×4 or 2×6 wooden studs, a sill plate 12, such as a wooden sill plate, as well as window jambs and door jambs, among other structures (not shown). The frame 10 is anchored to a building foundation 13, such as an on-grade concrete slab, by being anchored to the sill plate 12, which is in turn anchored to the foundation 13, by bolts. Insulation 14 is typically disposed between the studs 11 to thermally “proof” the structure 10.

Building paper 16, such as waterproof building paper, and a metal lath or wire mesh 17 are generally attached to the frame 10 by fasteners, for example, staples or furring nails, before a stucco sheathing 18 is applied over the wire mesh 17 as an exterior finish to the frame 10. Typically, the stucco sheathing 18 is applied over the wire mesh 17, such that bonding occurs between stucco sheathing 18 and the wire mesh 17. The stucco sheathing 18 may be applied in several coats, such as three coats.

A drip screed 19 may be installed between the building frame 10 and stucco sheathing 18, for example, at a base of the frame 10. The drip screed 19 helps prevent moisture from entering the juncture of the bottom of the frame 10 and the finish floor portion of the foundation 13.

A fastening device or fastener 20, such as a screw fastener, may be inserted through the stucco sheathing 18 and into the frame 10 to maintain the structural integrity and enhance the lateral strength of the stucco sheathing 18. Preferably, the fastener 20 is the stucco fastener described in Provisional Application No. 60/309,802, and co-pending U.S. patent application No. ______ (Our ref. S196:48276), the disclosures of which are incorporated herein by reference.

The fastener 20 may be installed to retrofit to existing stucco sheathings. The fastener 20 may be specially designed to transfer shearing loads from the stucco sheathing 18 to the frame 10. In such a case, the frame 10 transfers the shearing forces to the sill plate 12 and the building foundation 13 during sudden intense lateral movement, such as that generated by seismic and/or hurricane forces. As a result, the stucco sheathing 18 will resist greater lateral loads and experience less lateral displacement prior to failure.

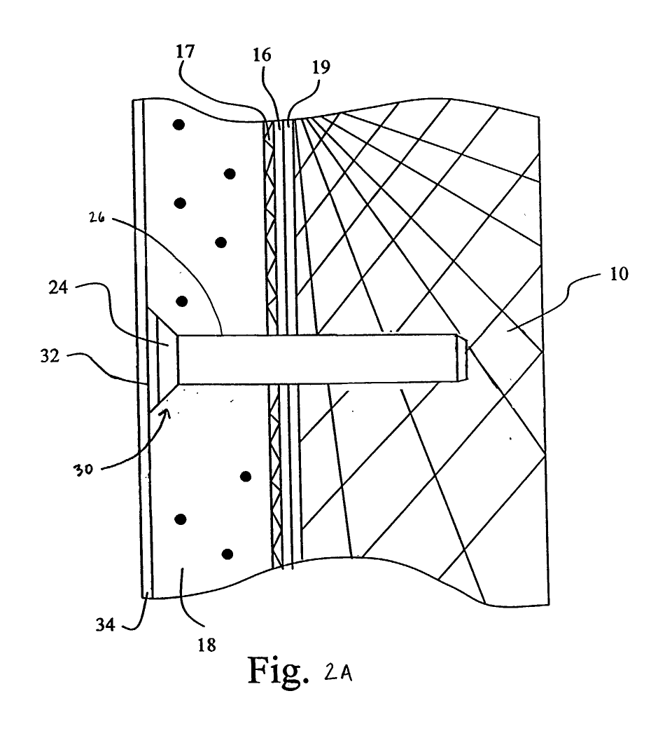

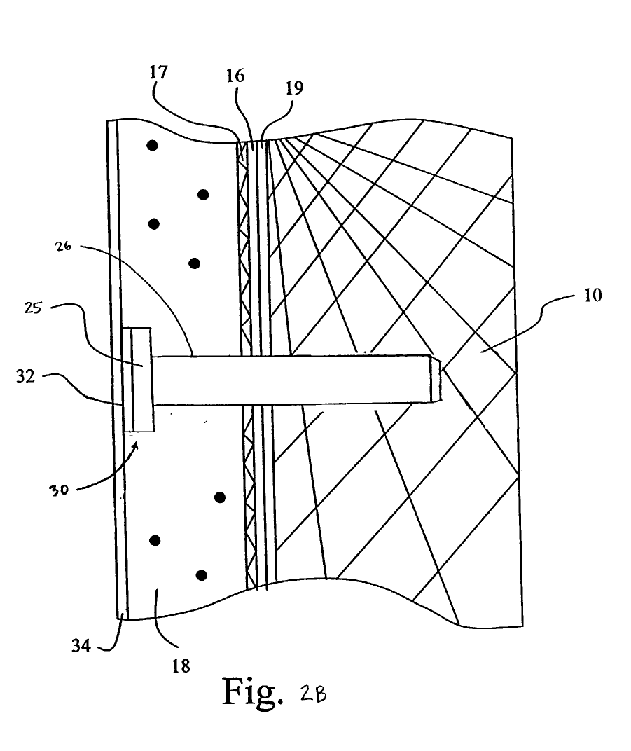

As shown in FIG. 2A, a hole 30, such as a countersunk pilot hole, may be drilled through the stucco sheathing 18, the wire mesh 17, the building paper 16, the drip screed 19 (where applicable), and at least partially into the frame 10. A plurality of the holes 30 may be spaced about the frame 10. For example, the holes 30 may be uniformly spaced along the studs 11 and sill plate 12, 8 inches on center (i.e., a distance of 8 inches from the center of one drill hole to the center of another drill hole). The holes 30 may be disposed along studs forming the base structure, base sill plates, door jambs, window jambs and other edges of the wall.

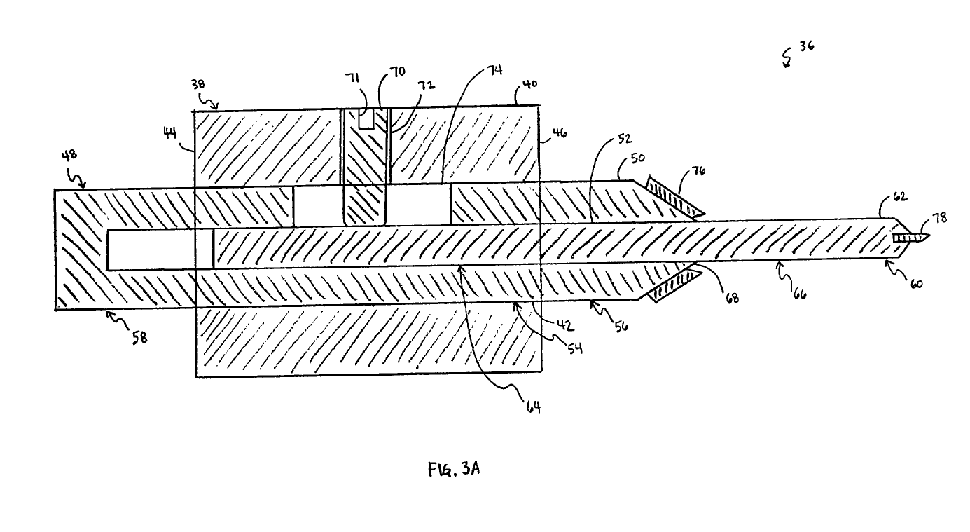

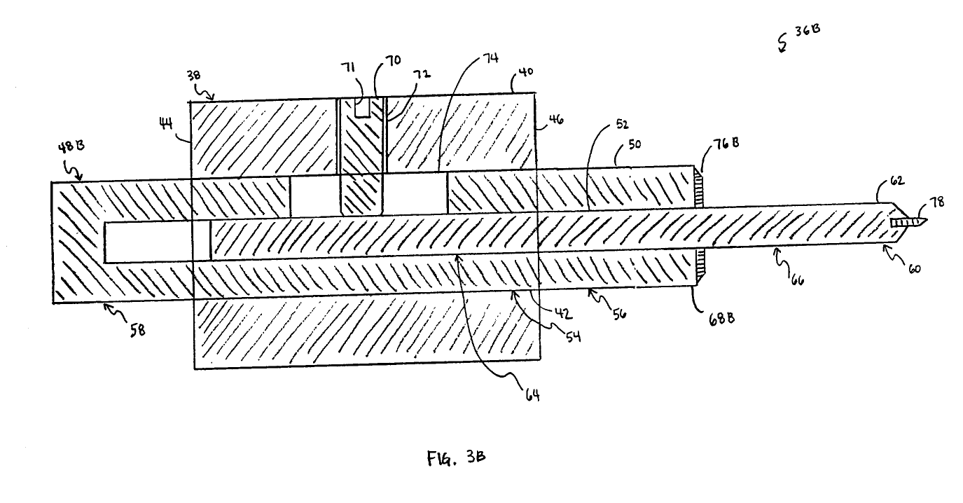

The holes 30 are drilled by use of the drill bit assembly 36 shown in FIG. 3A. The drill bit assembly 36 comprises a housing 38 having an outer diameter 40 and an inner diameter 42. The housing 38 has a proximal radial shoulder 44 and a distal radial shoulder 46, wherein each shoulder 44 and 46 extends between the housing outer diameter 40 and the housing inner diameter 42. In the depicted embodiment, the housing 38 is generally cylindrical, however, the housing 38 may be formed in other configurations as well, such as rectangular, or ovular. Similarly, in the depicted embodiment, the housing outer diameter 40 and the housing inner diameter 42 are each generally cylindrical, however, the housing outer diameter 40 and the housing inner diameter 42 may be formed in other configurations as well, such as rectangular, or ovular, among other configurations. In addition, it is not necessary that the housing outer diameter 40 and the housing inner diameter 42 have the same configuration as each other.

FIG. 3A also shows a first drill bit 48 comprising an outer diameter 50 and an inner diameter 52. Preferably, the first drill bit outer diameter 50 has a shape and size similar to the shape and size of the housing inner diameter 42, with the first drill bit outer diameter 50 being less than the housing inner diameter 42. In such an arrangement, the first drill bit outer diameter 50 may be slidably mounted within the housing inner diameter 42.

The first drill bit 48 comprises a shank portion 54 that is mounted within the housing inner diameter 42 and a drill portion 56 that extends from the shank portion 54 and axially protrudes from the housing distal radial shoulder 46. In addition, the first drill bit shank portion 54 may comprise an attachment portion 58 that axially protrudes from the housing proximal radial shoulder 44, such that the attachment portion 58 may be attached to a drill, such as an electric drill (not shown). In the depicted embodiment, the first drill bit 48 is concentrically slidably mounted to the drill bit assembly housing 38.

FIG. 3A also shows a second drill bit 60 comprising an outer diameter 62. Preferably, the second drill bit outer diameter 62 has a shape and size similar to the shape and size of the first drill bit inner diameter 52, with the second drill bit outer diameter 62 being less than the first drill bit inner diameter 52. In such an arrangement, the second drill bit outer diameter 62 may be slidably mounted within the first drill bit inner diameter 52.

The second drill bit 60 comprises a shank portion 64 that is mounted within the first drill bit inner diameter 52 and a drill portion 66 that extends from the shank portion 64 and axially protrudes from a distal end 68 of the first drill bit 48. In the depicted embodiment, the second drill bit 60 is concentrically slidably mounted to the first drill bit 48. Preferably, the first drill bit outer diameter 50 is larger than the second drill bit outer diameter 62.

The drill bit assembly 36 may also comprise a fastener 70 that is releasably secured to a housing lateral opening 72, wherein the housing lateral opening 72 extends from the housing inner diameter 42 to the housing outer diameter 40. In the depicted embodiment, the fastener 70 is a set screw having external threads that mate with internal threads in the housing lateral opening 72 to releasably secure the set screw within the housing lateral opening 72. The fastener 70 has a locked position, wherein an axial length of-the first drill bit drill portion 56 and an axial length of the second drill bit drill portion 66 are fixed. The fastener 70 may also comprise an unlocked position, wherein the axial length of the first drill bit drill portion 56 and the axial length of the second drill bit drill portion 66 are adjustable. The set screw preferably comprises a hexagonal opening 71 that mates with a hexagonal wrench, to enable the set screw to be easily moved between the locked and unlocked positions.

The first drill bit 48 may comprise a lateral opening 74 that extends from the first drill bit inner diameter 52 to the first drill bit outer diameter 50. In the depicted embodiment, the first drill bit lateral opening 74 registers with the housing lateral opening 72 to allow the fastener 70 to removably engage the second drill bit 60, such that when the fastener 70 engages the second drill bit 60, the axial length of the second drill bit drill portion 66 is fixed, and when the fastener 70 is not engaged with the second drill bit 60, the axial length of the second drill bit drill portion 66 is adjustable.

One method of adjusting the axial length of the second drill bit drill portion 66 comprises aligning the housing lateral opening 72 with the first drill bit lateral opening 74, adjusting the axial length of the second drill bit drill portion 66 to a desired length by axially displacing the second drill bit drill portion 66 with respect to the first drill bit 48, and securing the fastener 70 to the second drill bit 60 to fix the second drill bit drill portion 66 at its desired length.

In one embodiment, the first drill bit lateral opening 74 is a slot that longitudinally extends along a section of the first drill bit shank portion 54. The slot provides a continuum (a plurality) of mating positions with the housing lateral opening 72, such that the fastener 70 may removably engage the second drill bit 60 at any one of a number of mating positions between the slot and the housing lateral opening 72, such that the axial length of the first drill bit drill portion 56 is adjustable by varying the mating position of the slot and the housing lateral opening 72.

One method of adjusting the axial length of the first drill bit drill portion 56 comprises aligning the housing lateral opening 72 with the first drill bit slot, adjusting the axial length of the first drill bit drill portion 56 to a desired length by axially displacing the first drill bit drill portion 56 with respect to the drill bit assembly housing 38, and securing the fastener 70 to the second drill bit 60, which in turn applies a force to the first drill bit shank portion 54 to fix the first drill bit drill portion 56 at its desired length.

The drill bit assembly housing 38, the first drill bit 48 and the second drill bit 60 may each be comprised of any one of a variety of materials. In a preferred embodiment, the drill bit assembly housing 38, the first drill bit 48 and the second drill bit 60 are each comprised of a machine-grade steel, such as 1033 steel. In addition, the first drill bit 48 and the second drill bit 60 may each comprise at least one cutting tool 76 and 78. Each of the at least one first drill bit cutting tool 76 and each of the at least one second drill bit cutting tool 78 may be comprised of a material that is harder than the material of the drill bit to which it is attached. For instance, the first and second drill bits 48 and 60 may be comprised of a machine-grade steel and each of the cutting tools 76 and 78 may be comprised of tungsten.

In the depicted embodiment of FIG. 3A, the first drill bit distal end 68 is tapered, which allows the at least one first drill bit cutting tool 76 to produce a conically shaped opening. For example, FIG. 2A shows the stucco sheathing 18 and the structural framing 10 after being drilled by the drill bit assembly 36. As shown, the drill bit assembly 36 produces the hole 30 having a conically shaped second opening 24 that is produced by the first drill bit 48, and a cylindrically shaped second opening 26 that is produced by the second drill bit 60. As shown in the depicted embodiment of FIG. 2A, the drill bit assembly 36 produces the hole 30 in the form of a countersunk opening, wherein the conically shaped second opening 24 is concentric with the cylindrically shaped second opening 26.

FIG. 3B shows an alternative embodiment. The depicted embodiment of FIG. 3B includes a drill bit assembly 36B having a first drill bit 48 with a generally cylindrical distal end 68B and at least one cutting tool 76B that produces a cylindrically shaped opening. For example, FIG. 2B shows the stucco sheathing 18 and the structural framing 10 after being drilled by the drill bit assembly 36B. As shown, the drill bit assembly 36B produces the hole 30 having a cylindrically shaped second opening 25 that is produced by the first drill bit 48B, and the cylindrically shaped second opening 26B that is produced by the second drill bit 60. As shown in the depicted embodiment of FIG. 2B, the drill bit assembly 36B produces the hole 30 in the form of a countersunk opening, wherein the larger cylindrically shaped second opening 24 is concentric with the smaller cylindrically shaped second opening 26.

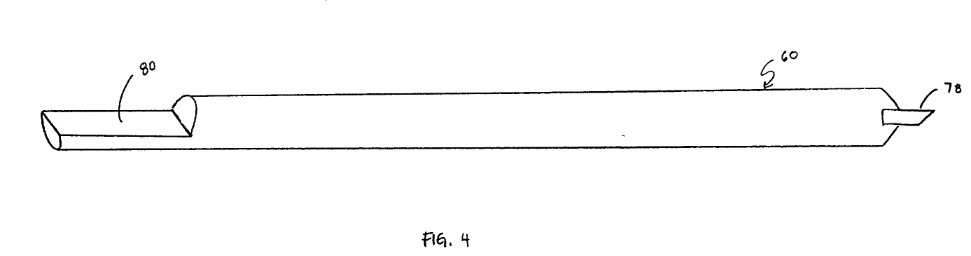

In an alternative embodiment shown in FIG. 4, a section 80 of the second drill bit shank portion 64 is flat, so that the fastener 70 has a flat surface to engage when the fastener 70 is in the locked position.

After the drill bit assembly 36 has been used to create the holes 30 (as shown in FIG. 2), the stucco fastener 20 is installed within each hole 30. The holes 30 may then be filled with an epoxy enhanced stucco patch material 32, for example caulking. In addition, the outer surface of the stucco sheathing 18 may be coated with a color coat or a finishing layer of stucco 34. Alternatively, texture may be provided over the patch material 32 to match the finish of the outer surface of the stucco sheathing 18.

It is important to note that when retrofitting the fasteners 20 to existing stucco sheathings, the existing stucco sheathings should be initially investigated to confirm that they are in good enough condition to warrant reinforcing the existing stucco sheathings with the fasteners 20 to improve the lateral resistance of the existing stucco sheathings. In addition, it is also advisable when retrofitting the fasteners 20 to existing stucco sheathings to inspect the frame 10 for dry rot, fungus and/or termite damage or any other damage that would lessen the advantage of applying the fasteners 20 to the existing stucco sheathings.

It is preferred that the fasteners 20 be installed to exterior stucco sheathing prior to color coating. By this is it meant the color coating which typically occurs every 10 to 15 years, where the outer surface of existing stucco sheathings are provided with a thin new coat of stucco, such as the layer 34 described above. Installing the fasteners 20 prior to color coating may reduce the cost of maintenance of the stucco sheathing, as fasteners 20 may be retrofitted to the existing stucco sheathing around the same time when the color coating is applied.

The preceding description has been presented with reference to certain embodiments of the invention. Workers skilled in the art and technology to which this invention pertains will appreciate that alterations and changes in the described structure may be practiced without meaningfully departing from the principal, spirit and scope of the invention. Accordingly, the foregoing description should not be read as pertaining only to the precise structures described and illustrated in the accompanying drawings, but rather should be read consistent with and as support to the appended claims which are to have their fullest and fair scope.

What is claimed is:

1. A drill bit assembly comprising:
a housing having an outer diameter, an inner diameter and a distal radial shoulder extending therebetween at a distal end of the housing;
a first drill bit having an outer diameter and an inner diameter, wherein the first drill bit outer diameter is less than the housing inner diameter, and wherein the first drill bit has a shank portion that is mounted within the housing inner diameter and a drill portion that extends from the shank portion and axially protrudes from the distal radial shoulder of the housing; and
a second drill bit having an outer diameter that is less than the first drill bit inner diameter, wherein the second drill bit has a shank portion that is mounted within the inner diameter of the first drill bit and a drill portion that extends from the shank portion and axially protrudes from a distal end of the first drill bit, and wherein the first drill bit outer diameter is larger than the second drill bit outer diameter.

2. The drill bit assembly of claim 1, wherein the first drill bit shank portion is slidably mounted within the housing inner diameter, such that an axial length of the first drill bit drill portion is adjustable.

3. The drill bit assembly of claim 2, wherein the second drill bit shank portion is slidably mounted within the first drill bit inner diameter, such that an axial length of the second drill bit drill portion is adjustable.

4. The drill bit assembly of claim 1, further comprising a fastener releasably secured to a housing lateral opening that extends from the housing inner diameter to the housing outer diameter, and wherein the fastener has a locked position, such that when the fastener is in the locked position an axial length of the first drill bit drill portion is fixed and an axial length of the second drill bit drill portion is fixed.

5. The drill bit assembly of claim 4, wherein the fastener is a set screw having external threads that mate with internal threads in the housing lateral opening to releasably secure the set screw within the housing lateral opening.

6. The drill bit assembly of claim 4, wherein the first drill bit has a lateral opening that extends from the first drill bit inner diameter to the first drill bit outer diameter, the first drill bit lateral opening mating with the housing lateral opening to allow the fastener to removably engage the second drill bit, wherein when the fastener is in the locked position the axial length of the second drill bit drill portion is fixed, and when the fastener is in an unlocked position the axial length of the second drill bit drill portion is adjustable.

7. The drill bit assembly of claim 6, wherein the first drill bit lateral opening is a slot that longitudinally extends along a section of the first drill bit shank portion, the slot having a plurality of mating positions with the housing lateral opening, such that the fastener may removably engage the second drill bit at any one of the plurality of mating positions between the slot and the housing lateral opening, and wherein the axial length of the first drill bit drill portion is adjustable by varying the mating position of the slot and the housing lateral opening.

8. The drill bit assembly of claim 1, wherein the first and second drill bits are each comprised of a machine-grade steel, and wherein the first and second drill bits each comprise at least one tungsten cutting tool.

9. A drill bit assembly comprising:
a generally cylindrical housing having an outer diameter, an inner diameter and a distal radial shoulder extending therebetween at a distal end of the housing;
a generally cylindrical first drill bit having an outer diameter and an inner diameter, wherein the first drill bit outer diameter is less than the housing inner diameter, and wherein the first drill bit has a shank portion that is concentrically slidably mounted within the housing inner diameter and a drill portion that extends from the shank portion and axially protrudes from the distal radial shoulder of the housing, such that an axial length of the drill portion of the first drill bit is adjustable; and
a generally cylindrical second drill bit having an outer diameter that is less than the first drill bit inner diameter, wherein the second drill bit has a shank portion that is concentrically slidably mounted within the first drill bit inner diameter and a drill portion that extends from the shank portion and axially protrudes from a distal end of the first drill bit, such that an axial length of the second drill bit drill portion is adjustable, and wherein the first drill bit outer diameter is larger than the second drill bit outer diameter.

10. The drill bit assembly of claim 9, further comprising a fastener releasably secured to a housing lateral opening that extends from the housing inner diameter to the housing outer diameter, and wherein the fastener has a locked position, such that when the fastener is in the locked position the axial length of the drill portion of the first drill bit is fixed and the axial length of the second drill bit drill portion is fixed.

11. The drill bit assembly of claim 10, wherein the fastener is a set screw having external threads that mate with internal threads in the housing lateral opening to releasably secure the set screw within the housing lateral opening.

12. The drill bit assembly of claim 10, wherein the first drill bit has a lateral opening that extends from the first drill bit inner diameter to the first drill bit outer diameter, the first drill bit lateral opening mating with the housing lateral opening to allow the fastener to removably engage the second drill bit, wherein when the fastener is in the locked position the axial length of the second drill bit drill portion is fixed, and when the fastener is in an unlocked position the axial length of the second drill bit drill portion is adjustable.

13. The drill bit assembly of claim 12, wherein the first drill bit lateral opening is a slot that longitudinally extends along a section of the first drill bit shank portion, the slot having a plurality of mating positions with the housing lateral opening, such that the fastener may removably engage the second drill bit at any one of the plurality of mating positions between the slot and the housing lateral opening, and wherein the axial length of the first drill bit drill portion is adjustable by varying the mating position of the slot and the housing lateral opening.

14. The drill bit assembly of claim 9, wherein a section of the second drill bit shank portion is flat and wherein the fastener engages the second drill bit flat section when the fastener is in the locked position.

15. The drill bit assembly of claim 9, wherein the first and second drill bits are each comprised of a machine-grade steel, and wherein the first and second drill bits each comprise at least one tungsten cutting tool.

16. A method of improving a lateral resistance of a stucco sheathing that is attached to a building frame comprising:
providing a building frame;
providing one or more layers of stucco sheathing;
providing a drill bit assembly comprising:
a generally cylindrical housing having an outer diameter, an inner diameter and a distal radial shoulder extending therebetween at a distal end of the housing;
a generally cylindrical first drill bit having an outer diameter and an inner diameter, wherein the first drill bit outer diameter is less than the housing inner diameter, and wherein the first drill bit has a shank portion that is mounted within the housing inner diameter and a drill portion that extends from the shank portion and axially protrudes from the distal radial shoulder of the housing; and
a generally cylindrical second drill bit having an outer diameter that is less than the first drill bit inner diameter, wherein the second drill bit has a shank portion that is mounted within the first drill bit inner diameter and a drill portion that extends from the shank portion and axially protrudes from a distal end of the first drill bit, and wherein the first drill bit outer diameter is larger than the second drill bit outer diameter;
drilling a plurality of holes by use of the drill bit assembly, wherein each hole extends through the stucco sheathing and into the building frame;
installing a stucco fastener in each drilled hole to secure the stucco sheathing to the building frame.

17. The method of claim 16, further comprising:
concentrically slidably mounting the first drill bit shank portion within the housing inner diameter; and
concentrically slidably mounting the second drill bit shank portion within the first drill bit inner diameter.

18. The method of claim 17, further comprising:
providing a fastener that releasably secures to a housing lateral opening that extends from the housing inner diameter to the housing outer diameter;
providing a first drill bit lateral opening that extends from the first drill bit inner diameter to the first drill bit outer diameter;
aligning the housing lateral opening with the first drill bit lateral opening;
adjusting an axial length of the second drill bit drill portion to a desired length by axially displacing the second drill bit drill portion with respect to the first drill bit;
securing the fastener to the second drill bit to fix the second drill bit drill portion to its desired length.

19. The method of claim 18, wherein the first drill bit lateral opening is a slot that longitudinally extends along a section of the first drill bit shank portion, the method further comprising:
aligning the housing lateral opening with the first drill bit slot;
adjusting an axial length of the first drill bit drill portion to a desired length by axially displacing the first drill bit drill portion with respect to the housing; and
securing the fastener to the second drill bit, which in turn applies a force to the first drill bit shank portion to fix the first drill bit drill portion to its desired length.

20. The method of claim 18, wherein the fastener is a set screw having external threads and the housing lateral opening has internal threads that mate with the external threads of the set screw to releasably secure the set screw within the housing lateral opening.
